(19) United States
(12) Patent Application Publication
(10) Pub. No.: US 2021/0123569 A1
(43) Pub. Date: Apr. 29, 2021

(54) Inspection Method and Associated Computer Software

(71) Applicant: E M & I (MARITIME) LIMITED, Saint Helier (GB)

(72) Inventor: Daniel Constantinis, Naxxar (MT)

(73) Assignee: E M & I (MARITIME) LIMITED, Saint Helier (GB)

(21) Appl. No.: 17/046,594

(22) PCT Filed: Apr. 11, 2019
(86) PCT No.: PCT/GB2019/051045

§ 371 Date: Oct. 9, 2020

(30) Foreign Application Priority Data
Apr. 11, 2018 (GB) 1806017.8

(51) Int. Cl. F17C 13/12; G01N 21/954

(52) U.S. Cl. CPC F17C 13/126; G01N 21/954

(57) ABSTRACT

Method of inspecting at least a portion (10) of a pressure system. The method comprises analysing data to predict a property of the portion of the pressure system. The predicted property (12) is predicted for a particular use parameter. The method comprises determining an amount of data to collect at a next inspection of the portion (10) of the pressure system.

The present invention relates to a method of inspecting an object, particularly, but not exclusively, a vessel; and associated apparatus.

### BACKGROUND

The Oil/Gas and indeed many other industries are concerned with safety risks. There are numerous objects, such as electrical components or vessels (e.g. pressure vessels), on Oil/Gas assets that are often safety critical and need to comply with regulatory and corporate standards. Additional risks are encountered when the confined space involves working at height, for example in a large storage tank or on a ship or offshore production facility.

However, at least some situations require personnel entry into such confined spaces. For example, industries, such as Oil/Gas, stipulate a regulatory and classification requirement to inspect these confined spaces at regular intervals to assure the integrity of the structure. Such inspections involve having a competent person carry out a General Visual Inspection (GVI) and a Close Visual Inspection (CVI) of critical parts of the structure and an assessment of any structural deformation by various visual and/or mechanical means.

These inspections are normally carried out by making the tank safe for man entry, cleaning the surfaces to be inspected to a given standard and providing safe access and egress to the components that require inspection. This requires considerable time, cost and renders the tank unavailable for use.

Where the structure shows signs of corrosion then there may be a further requirement to measure the remaining thickness of the steel to confirm the structural and leak integrity of the component or tank respectively.

Regulators and classification societies have prescribed that any inspection methods must provide a particular quality and scope of inspection to provide a GVI, CVI, structural deformation survey and wall thickness measurement of critical components where there is evidence of corrosion.

Furthermore, inspections may be required in hazardous areas. Hazardous areas are typically areas where flammable liquids, vapours, gases or combustible dusts are likely to occur in quantities sufficient to cause a hazard risk, such as of fire or explosion. Hazardous environments or areas are sometimes referred to as “Ex Locations”, “Zoned Areas”, “Explosive Atmospheres” or “ATEX Areas”. Consequently, equipment that is certified for use in these areas is often called “ATEX Equipment”, “HAE” or “Ex Equipment”. Equipment can have various terms or ratings, such as “Ex d” (Flameproof), “Ex e” (Increased Safety), “Ex I” (Intrinsic Safety) and “Ex p” (Pressurised).

International requirements and guidelines for general and detailed inspections, such as an ATEX Directive (e.g. 2014/34/EU) in the EU (or equivalent harmonised international IECEx standards), can include detailed inspections of components such as junction boxes, connectors, lighting systems and glands. Often, large numbers of components or equipment are involved, with some assets or facilities having tens of thousands or more objects in hazardous areas. Accordingly, inspection can be an onerous requirement. The detailed inspections require isolating the systems and opening up the component for inspection and reassembly. During the operating life cycle of the asset, inspections can be difficult because of the location of the components, which often necessitates staging or rope access COMPEX certified electrical inspectors to carry out the inspections. Inspections can reveal faults or defects in the components that may have been present since manufacture or assembly.

Inspection of pressure systems and other components on large industrial assets both on and offshore is costly but needed to meet regulatory requirements and to optimise maintenance.

Previously, the present inventor has attempted to improve inspection, such as disclosed in WO2017/191447, the contents of which are incorporated herein.

It may be an object of one or more aspects, examples, embodiments, or claims of the present disclosure to at least mitigate or ameliorate one or more problems associated with the prior art.

### SUMMARY

According to an aspect of the invention, there is provided a method of inspecting an object. The method may comprise compiling data, such as historical data. The object may comprise a system or portion thereof. The system may comprise a pressure system. The pressure system may comprise one or more pressure vessel/s. The object may comprise a pressure vessel.

The method may comprise analysing data to predict or to project a property or characteristic of the object. The property or characteristic may comprise a current or existing property or characteristic. Additionally, or alternatively, the property or characteristic may comprise a future property or characteristic. The property or characteristic may comprise a known or a measured property or characteristic. Additionally, or alternatively, the property or characteristic may comprise an unknown or an unmeasured property or characteristic, such as a target property or characteristic. The predicted or projected property or characteristic may be predicted or projected for a particular parameter or variable, such as a particular time or use parameter. In at least some examples, the predicted or projected property or characteristic may be associated with a life or use of the object. Accordingly, a development of the property or characteristic may be predicted or projected over a period of time.

The method may comprise generating a model or simulation of the object and/or the property or characteristic thereof. The mode or simulation may comprise an effective fingerprint associated with the object. The method may comprise fingerprinting the object. For example, the method may comprise associating each object with a unique data set. The unique data set may be indicative of the property/ies or characteristic/s of the object at a plurality of locations of the object, such as distributed along or through the object. The method may comprise analysing the object to determine the property or characteristic and or location/s of the object corresponding to the property or characteristic. The property or characteristic may comprise a wall thickness, such as a minimum wall thickness.

The method may comprise determining a predicted or projected wall thickness. The method may comprise determining a predicted or projected wall thickness of one or more object/s at one or more location of the object/s. The predicted or projected wall thickness may comprise a minimum thickness.

The method may comprise determining a predicted or projected wall thickness in dependence on one or more parameter/s. The one or more parameter/s may comprise historical data. The historical data may comprise data for the object for which the wall thickness is to be predicted or projected, such as compiled from previous inspection/s, measurement/s and/or determinations. The previous inspection/s, measurement/s and/or determinations may be of the object. Additionally, or alternatively, the historical data may comprise data for other objects, such as with one or more similar traits or features to the object for which the wall thickness is to be predicted or projected. The one or more similar traits or features may comprise one or more of: an object type; a material type; a starting wall thickness; an environment of use; a pressure of use; a system of use; a fluid for use therewith or therein.

The method may comprise determining an amount of data to collect at an inspection, such as a next inspection, of the object. For example, the method may comprise determining a number of thickness readings required to confirm the predicted or projected wall thickness. The method may comprise determining an amount of data to collect to satisfy a level of certainty and/or probability. For example, the method may comprise determining the number of thickness readings of the object that are required to confirm the predicted or projected minimum wall thickness. Confirming the predicted or projected minimum wall thickness may comprise confirming the predicted or projected wall thickness to the level of certainty and/or probability.

The method may comprise corroborating that sufficient data has been collected. The method may comprise corroborating that sufficient data has been collected to confirm that the updated minimum wall thickness has been predicated with a level of certainty, such as a predetermined and/or minimum level of certainty. The level of certainty may comprise an agreed level of certainty.

The method may comprise determining whether the predicted or projected property or characteristic is acceptable. For example, the method may comprise determining that the minimum wall thickness is above a minimum threshold. The minimum threshold may correspond to a minimum safe threshold, such as identified by a risk analysis and/or regulatory requirement. The minimum threshold may correspond to a minimum allowable wall thickness. The method may comprise providing an alert or trigger to inspect and/or repair or replace the object where the predicted or projected minimum wall thickness reaches the threshold. The method may comprise determining the predicted or projected property or characteristic in advance of an inspection, such as a planned or scheduled inspection. Additionally, or alternatively, the method may comprise determining the predicted or projected property or characteristic when no inspection is planned or scheduled. Accordingly, the method may comprise providing the predicted or projected property or characteristic when no inspection data is scheduled or planned to become available.

The method may comprise determining whether sufficient data has or is being gathered by an inspection. The method may comprise determining whether sufficient data has or is being gathered by an inspection to confirm the property or characteristic. The method may comprise determining whether sufficient data has or is being gathered by an inspection to confirm the predicted or projected property or characteristic. For example, the method may comprise determining whether sufficient data is being collected during an inspection to confirm to the level of certainty, such as the agreed level of certainty. The method may comprise providing an indication to a user. For example, the method may comprise providing an indication to the user whether sufficient data is or has been collected. For example, the method may comprise notifying the user during inspection when sufficient data has been gathered during the inspection. Accordingly, the user can complete or terminate at least that portion of the inspection, with certainty that sufficient data has been gathered. It will be appreciated, that the method may enable curtailment of inspection, such as when gathered data reaches a threshold corresponding to the level of certainty. The method may comprise providing notification and/or determinations, such as predictions or projections, during inspection, such as during the gathering if data (e.g. performing thickness measurements).

The method may comprise minimising an amount of data. The method may comprise minimising an amount of data analysed. The method may comprise minimising the amount of data acquired or required by inspection. The method may comprise minimising the amount of data acquired or required by a single inspection. The method may comprise minimising the amount of data acquired or required by a plurality of inspections, such as a plurality of inspections spaced over a period of time. The method may comprise minimising the amount of data acquired or required by each inspection. The method may comprise minimising the number and/or resolution and/or frequency of inspection/s. In at least some examples, it may be an advantage of the method that the time and/or cost associated with inspecting the object is reduced, such as over a period of time, particularly relative to conventional inspection methods.

The method may comprise projecting how the object will age. The method may comprise projecting how much inspection data is required to assure the operator and regulator that the risk is within a pre-agreed level.

The method may comprise adapting the model. The method may comprise adapting the model in dependence on data gathered by inspection, such as gathered by each inspection. The method may comprise adapting the model to refine the prediction/s or projection/s. The method may comprise adapting the model to refine the amount of data to collect, such as to reduce the amount of data to collect. The method may comprise adapting the model to refine the amount of data to collect within the level of certainty and/or probability.

In at least some examples, the method comprises at least mitigating against an unexpected loss of containment of the fluids inside high risk piping or pressure vessels. For example, the method may comprise at least mitigating against excessive external or internal corrosion of the pressure retaining walls to the extent where at some point in the pressure system the remaining wall thickness is no longer able to contain the pressure of the contained fluids. The method may comprise a risk based inspection (RBI) to focus inspection methods and inspection intervals on the probable failure mechanisms of high risk objects or components.

The method may comprise determining the amount of data to be collected to provide inspection thickness data and a required ‘confidence factor’ that assures the stakeholders that it is improbable that any part of the object, such as the pressure system, is going to fail under normal operating conditions.

The object may comprise the vessel. The vessel may be on or part of a moving ship or Floating Production, Storage and Offloading unit (FPSO) or Mobile Offshore Drilling Unit or Accommodation Vessel for example. The method may comprise a short-range inspection. The vessel may comprise a container, such as for containing a material, fluid, or the like.

The vessel may be referred to as a confined space. The vessel may be tens of meters in one or more of length, depth and height. The vessel may be a tank on and/or part of a ship. The ship may be a drillship or a cargo ship. The tank may be a ballast and/or water ballast tank. The tank may be a fuel and/or oil tank. The tank may be a J-tank. The vessel may be on or part of a Floating Production, Storage and Offloading unit (FPSO). The vessel may be a pressure vessel.

The object may be for, in or from a hazardous environment or area. The object may comprise hazardous area apparatus or equipment, or at least a component thereof. The method may comprise a non-invasive inspection. The method may comprise the inspection of an electrical and/or electronic component/s or system/s. The method may comprise obtaining a inspection result, such as a inspection image, of the object. The method may comprise inspection without isolating the object, such as without electrically isolating the object. The method may comprise inspection without dismantling or disassembling the object, or component/s thereof.

It may be an advantage of the present invention, that method allows an effective management of the object or system, particularly given, for example, the number of items of equipment potentially involved, their accessibility, the varying risks they represent or a lack of prior or existing information on asset registers or current condition.

The method may comprise inspecting the object multiple times. The multiple times may be during a single inspection, such as separated by seconds or minutes; and/or during separate discrete inspections, such as separated by weeks, months and/or years. The method may comprise compiling data from multiple inspections. The method may comprise compiling data from multiple inspections of a single object. The method may comprise compiling data from multiple inspection of the single object over a lifespan, or period thereof, of the single object.

The method may comprise inspecting multiple objects. The method may comprise inspecting multiple objects during a single inspection. The single inspection may comprise multiple inspection scans and/or measurements, such as thickness measurements (e.g. ultrasonic or the like).

The method may comprise storing the inspection results and/or analysis/es or data derived therefrom, such as storing in a database. The method may comprise compiling the inspection results and/or analysis/es or data derived therefrom. The method may comprise compiling the inspection results and/or analysis/es or data over a period of time for a single object. Additionally, or alternatively, method may comprise compiling the inspection results and/or analysis/es or data for multiple objects.

The method may comprise analysing the compiled inspection results and/or analysis/es or data. The analysis may comprise a statistical analysis. The analysis may comprise a risk or risk factor analysis, such as a Failure Modes and Effects Analysis (FMEA) or the like. The method may comprise performing a targeted inspection. The method may comprise performing a targeted inspection in dependence on the compiled inspection results and/or analysis/es or data. The method may comprise performing a targeted inspection in dependence on a most likely and/or most critical failure location/s and/or object/s and/or feature/s.

The method may comprise compiling an inventory of objects, and/or inspection results and/or analysis/es or data associated therewith, such as in a database. The method may comprise grading the objects, such as by criticality—typically in dependence on the inspection results and/or analysis/es or data.

The method may comprise determining and/or following an inspection programme. The method may comprise identifying which object/s require or are likely to require inspection. The method may comprise identifying or determining a detailed procedure for the inspection of each object. The detailed procedure may be determined in dependence on a probable defect or failure type/s; and may comprise an associated, preferably validated, method for detecting such defects or failures. The detailed procedure may be determined in dependence on the analysis, such as an FM EA.

The steps of the method may be in any order. The method of inspecting the object may be referred to as a method of inspection.

It may be an advantage of the present invention that the method of inspection is equivalent or at least substantially equivalent, such as in quality and/or scope, to the inspection that a competent person would achieve with a conventional inspection, such as a prescribed or certified inspection or detailed inspection. It may be an advantage of the present invention that the method of inspecting the object is in a manner and/or quality and/or resolution at least equivalent to that required by regulation. The manner and/or quality and/or resolution may be at least equivalent to that obtainable by conventional inspection or general inspection, or at least comparable thereto. The manner and/or quality and/or resolution may be at least equivalent to that obtainable by visual inspection, or at least comparable thereto. The manner and/or quality and/or resolution may be at least equivalent to that obtainable by electrical testing. It may be an advantage of the present invention that the method of inspecting the object is in a manner and/or quality and/or resolution at least equivalent to that which a skilled surveyor or engineer would achieve if they had access to the object, such as with dismantling or disassembly, and optionally isolation, of the object.

It may be an advantage of the present invention that the method of inspecting the vessel is in a manner and/or quality and/or resolution at least equivalent to that required by regulation. The manner and/or quality and/or resolution may be at least equivalent to that obtainable by ultrasonic thickness measurement, or at least comparable thereto. It may be an advantage of the present invention that the method of inspecting the vessel is in a manner and/or quality and/or resolution at least equivalent to that which a skilled surveyor or engineer would achieve if they had access to all parts of the vessel including within ‘arm's length’ of components, such as subject to a Close Visual Inspection, in particular if the skilled surveyor or engineer were inside the vessel and had such access.

Inspecting the vessel may comprise inspecting an inside of the vessel. The method may comprise inspecting the vessel without a person entering or being required to enter the vessel. The method may comprise the entry of only apparatus, such as scanning apparatus, into the vessel.

According to an aspect of this invention, there is provided an apparatus configured to perform a method according to an aspect, claim, embodiment or example of this disclosure.

According to an aspect of the invention, there is provided a controller arranged to perform a method according to an aspect, claim, embodiment or example of this disclosure.

According to an aspect of the invention, there is provided a system comprising a controller according to an aspect, claim, embodiment or example of this disclosure, or a system arranged to perform a method according to an aspect, claim, embodiment or example of this disclosure.

According to an aspect of the invention, there is provided computer software which, when executed by a processing means, is arranged to perform a method according to any aspect, claim, embodiment or example of this disclosure. The computer software may be stored on a computer readable medium. The computer software may be tangibly stored on a computer readable medium. The computer readable medium may be non-transitory.

Any controller or controllers described herein may suitably comprise a control unit or computational device having one or more electronic processors. Thus, the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION

An embodiment of the invention will now be described by way of example only and with reference to the accompanying drawings, in which:

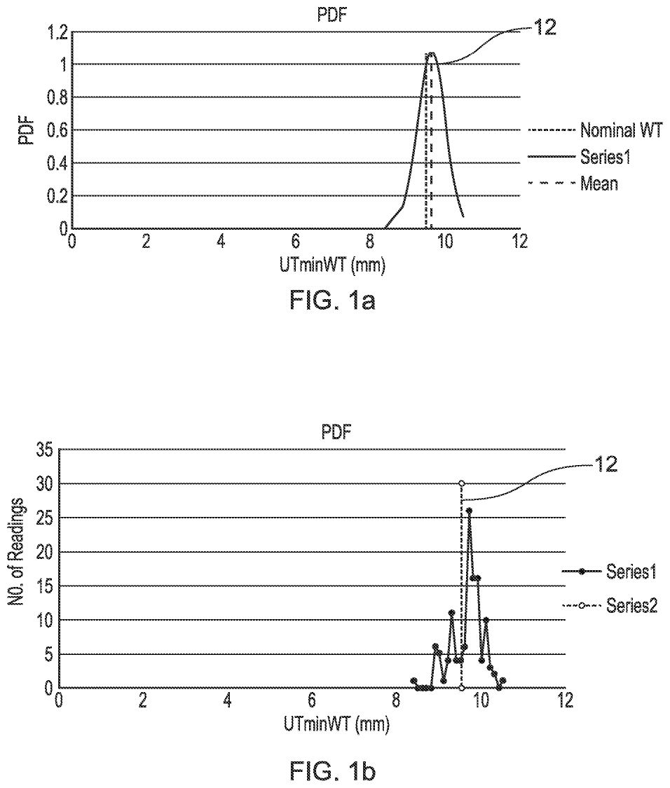

FIG. 1a shows a first model of a predicted property;

FIG. 1b shows a corresponding graph of the number of data points and the property;

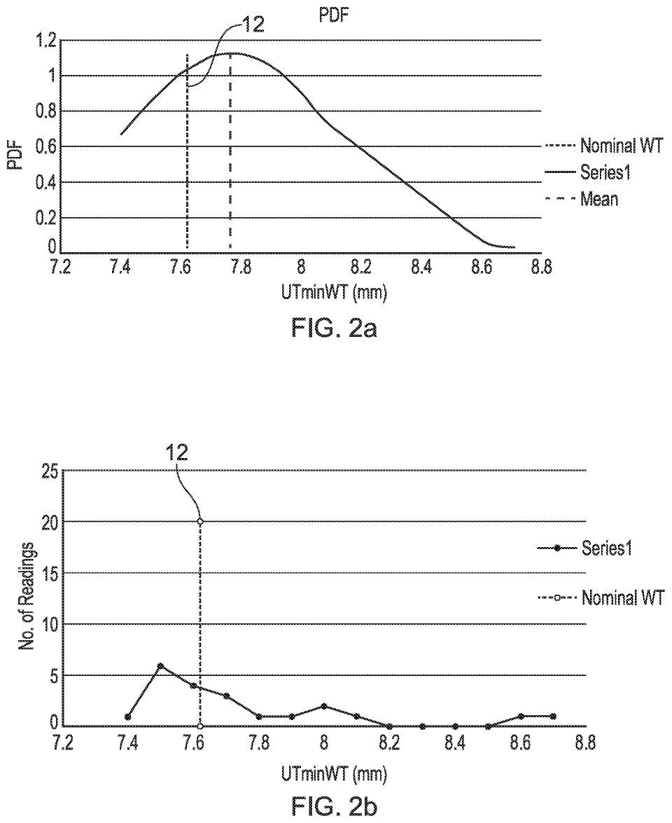

FIG. 2a shows a further model of a predicted property;

FIG. 2b shows a corresponding graph of the number of data points and the property; and

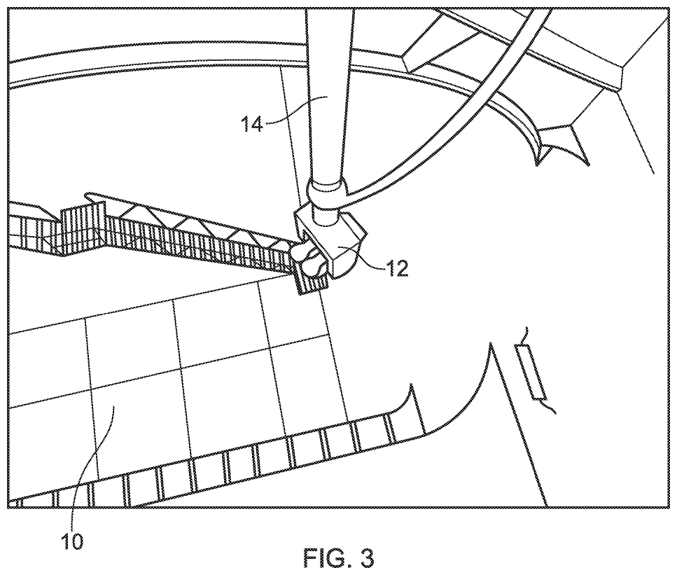

FIG. 3 shows an object according to an example.

### DETAILED DESCRIPTION

There is herein described a method of inspecting an object 10.

There is herein described a method of inspecting an object 10. The method comprises compiling data, such as historical data. The object 10 comprises a system or portion thereof. The system comprises a pressure system. The pressure system comprises one or more pressure vessel/s. The object 10 comprises a pressure vessel.

FIG. 1a shows a first model of a predicted property; and FIG. 1b shows a corresponding graph of the number of data points and the property. The property here is wall thickness, generally indicated by reference numeral 12.

Likewise, FIG. 2a shows a further model of a predicted property; and FIG. 2b shows a corresponding graph of the number of data points and the property. As can be seen from the figures, a number of readings, here thickness measurements, is given in FIGS. 1 b and 2b respectively. Accordingly, the method here predicts a wall thickness and corresponding number of readings required to confirm the wall thickness with an agreed level of certainty, as explained below.

The method here comprises analysing data to predict or to project a property or characteristic of the object 10. The property or characteristic here comprises a future property or characteristic. The property or characteristic comprises an unknown or an unmeasured property or characteristic, such as a target property or characteristic. The predicted or projected property or characteristic is predicted or projected for a particular parameter or variable, such as a particular time or use parameter. In at least some examples, the predicted or projected property or characteristic is associated with a life or use of the object 10. Accordingly, a development of the property or characteristic is predicted or projected over a period of time.

The method comprises generating a model or simulation of the object 10 and/or the property or characteristic thereof. The mode or simulation comprises an effective fingerprint associated with the object 10. The method comprises fingerprinting the object 10. For example, the method comprises associating each object 10 with a unique data set. The unique data set is indicative of the property/ies or characteristic/s of the object 10 at a plurality of locations of the object 10, such as distributed along or through the object 10. The method comprises analysing the object 10 to determine the property or characteristic and or location/s of the object 10 corresponding to the property or characteristic. The property or characteristic comprises a wall thickness, such as a minimum wall thickness 12.

The method comprises determining a predicted or projected wall thickness. The method comprises determining a predicted or projected wall thickness of one or more object 10/s at one or more location of the object 10/s. The predicted or projected wall thickness comprises a minimum thickness 12.

The method comprises determining a predicted or projected wall thickness in dependence on one or more parameter/s. The one or more parameter/s comprises historical data. The historical data comprises data for the object 10 for which the wall thickness is to be predicted or projected, such as compiled from previous inspection/s, measurement/s and/or determinations. The previous inspection/s, measurement/s and/or determinations is of the object 10. Additionally, or alternatively, the historical data comprises data for other object 10, such as with one or more similar traits or features to the object 10 for which the wall thickness is to be predicted or projected. The one or more similar traits or features comprises one or more of: an object 10 type; a material type; a starting wall thickness; an environment of use; a pressure of use; a system of use; a fluid for use therewith or therein.

The method comprises determining an amount of data to collect at an inspection, such as a next inspection, of the object 10. For example, the method comprises determining a number of thickness readings required to confirm the predicted or projected wall thickness. The method comprises determining an amount of data to collect to satisfy a level of certainty and/or probability. For example, the method comprises determining the number of thickness readings of the object 10 that are required to confirm the predicted or projected minimum wall thickness 12. Confirming the predicted or projected minimum wall thickness 12 comprises confirming the predicted or projected wall thickness to the level of certainty and/or probability.

The method comprises corroborating that sufficient data has been collected. The method comprises corroborating that sufficient data has been collected to confirm that the updated minimum wall thickness 12 has been predicated with a level of certainty, such as a predetermined and/or minimum level of certainty. The level of certainty comprises an agreed level of certainty.

The method comprises determining whether the predicted or projected property or characteristic is acceptable. For example, the method comprises determining that the minimum wall thickness 12 is above a minimum threshold. The minimum threshold corresponds to a minimum safe threshold, such as identified by a risk analysis and/or regulatory requirement. The minimum threshold corresponds to a minimum allowable wall thickness. The method comprises providing an alert or trigger to inspect and/or repair or replace the object 10 where the predicted or projected minimum wall thickness 12 reaches the threshold. The method comprises determining the predicted or projected property or characteristic in advance of an inspection, such as a planned or scheduled inspection. Additionally, or alternatively, the method comprises determining the predicted or projected property or characteristic when no inspection is planned or scheduled. Accordingly, the method comprises providing the predicted or projected property or characteristic when no inspection data is scheduled or planned to become available.

The method comprises determining whether sufficient data has or is being gathered by an inspection. The method comprises determining whether sufficient data has or is being gathered by an inspection to confirm the property or characteristic. The method comprises determining whether sufficient data has or is being gathered by an inspection to confirm the predicted or projected property or characteristic. For example, the method comprises determining whether sufficient data is being collected during an inspection to confirm to the level of certainty, such as the agreed level of certainty. The method comprises providing an indication to a user. For example, the method comprises providing an indication to the user whether sufficient data is or has been collected. For example, the method comprises notifying the user during inspection when sufficient data has been gathered during the inspection. Accordingly, the user can complete or terminate at least that portion of the inspection, with certainty that sufficient data has been gathered. It will be appreciated, that the method may enable curtailment of inspection, such as when gathered data reaches a threshold corresponding to the level of certainty. The method comprises providing notification and/or determinations, such as predictions or projections, during inspection, such as during the gathering if data (e.g. performing thickness measurements).

Here, the method comprises minimising an amount of data. The method comprises minimising an amount of data analysed. The method comprises minimising the amount of data acquired or required by inspection. The method comprises minimising the amount of data acquired or required by a single inspection. The method comprises minimising the amount of data acquired or required by a plurality of inspections, such as a plurality of inspections spaced over a period of time. The method comprises minimising the amount of data acquired or required by each inspection. The method comprises minimising the number and/or resolution and/or frequency of inspection/s. In at least some examples, it is an advantage of the method that the time and/or cost associated with inspecting the object 10 is reduced, such as over a period of time, particularly relative to conventional inspection methods.

The method comprises projecting how the object 10 will age. The method comprises projecting how much inspection data is required to assure the operator and regulator that the risk is within a pre-agreed level.

The method comprises adapting the model. The method comprises adapting the model in dependence on data gathered by inspection, such as gathered by each inspection. The method comprises adapting the model to refine the prediction/s or projection/s. The method comprises adapting the model to refine the amount of data to collect, such as to reduce the amount of data to collect. The method comprises adapting the model to refine the amount of data to collect within the level of certainty and/or probability. In at least some examples, the method comprises at least mitigating against an unexpected loss of containment of the fluids inside high risk piping or pressure vessels. For example, the method comprises at least mitigating against excessive external or internal corrosion of the pressure retaining walls to the extent where at some point in the pressure system the remaining wall thickness is no longer able to contain the pressure of the contained fluids. The method comprises a risk based inspection (RBI) to focus inspection methods and inspection intervals on the probable failure mechanisms of high risk object 10 or components.

The method comprises determining the amount of data to be collected to provide inspection thickness data and a required ‘confidence factor’ that assures the stakeholders that it is improbable that any part of the object 10, such as the pressure system, is going to fail under normal operating conditions.

FIG. 3 shows an object 10 according to an example, the object here 10 is a dry, empty vessel 10 which is a tank and a confined space. An inspection tool 12 is shown here mounted on a pole 10. The inspection tool 12 may be similar to that disclosed in FIG. 1 of WO2017/191447; although it will be appreciated that other inspection tools, such as wall thickness measurement tools (e.g. ultrasonic, electromagnetic, optical laser, or the like) may be used to obtain inspection data. The object 10 here comprises the vessel. The vessel is on or part of a moving ship or Floating Production, Storage and Offloading unit (FPSO) or Mobile Offshore Drilling Unit or Accommodation Vessel for example. The method comprises a short-range inspection. The vessel comprises a container, such as for containing a material, fluid, or the like. The vessel is referred to as a confined space. The vessel is tens of meters in one or more of length, depth and height. The vessel is a tank on and/or part of the Floating Production, Storage and Offloading unit (FPSO). The vessel is a pressure vessel.

In other examples (not shown), the object is for, in or from a hazardous environment or area. The object comprises hazardous area apparatus or equipment, or at least a component thereof. The method comprises a non-invasive inspection. The method comprises the inspection of an electrical and/or electronic component/s or system/s. The method comprises obtaining a inspection result, such as a inspection image, of the object. The method comprises inspection without isolating the object, such as without electrically isolating the object. The method comprises inspection without dismantling or disassembling the object, or component/s thereof.

It is an advantage of the present invention, that method allows an effective management of the object 10 or system, particularly given, for example, the number of items of equipment potentially involved, their accessibility, the varying risks they represent or a lack of prior or existing information on asset registers or current condition.

The method comprises inspecting the object 10 multiple times. The multiple times is during a single inspection, such as separated by seconds or minutes; and/or during separate discrete inspections, such as separated by weeks, months and/or years. The method comprises compiling data from multiple inspections. The method comprises compiling data from multiple inspections of a single object 10. The method comprises compiling data from multiple inspection of the single object 10 over a lifespan, or period thereof, of the single object 10.

The method comprises inspecting multiple object 10. The method comprises inspecting multiple object 10 during a single inspection. The single inspection comprises multiple inspection scans and/or measurements, such as thickness measurements (e.g. ultrasonic or the like).

The method comprises storing the inspection results and/or analysis/es or data derived therefrom, such as storing in a database. The method comprises compiling the inspection results and/or analysis/es or data derived therefrom. The method comprises compiling the inspection results and/or analysis/es or data over a period of time for a single object 10. Additionally, or alternatively, method comprises compiling the inspection results and/or analysis/es or data for multiple object 10.

The method comprises analysing the compiled inspection results and/or analysis/es or data. The analysis comprises a statistical analysis. The analysis comprises a risk or risk factor analysis, such as a Failure Modes and Effects Analysis (FMEA) or the like. The method comprises performing a targeted inspection. The method comprises performing a targeted inspection in dependence on the compiled inspection results and/or analysis/es or data. The method comprises performing a targeted inspection in dependence on a most likely and/or most critical failure location/s and/or object 10/s and/or feature/s.

The method comprises compiling an inventory of object 10, and/or inspection results and/or analysis/es or data associated therewith, such as in a database. The method comprises grading the object 10, such as by criticality—typically in dependence on the inspection results and/or analysis/es or data.

The method comprises determining and/or following an inspection programme. The method comprises identifying which object 10/s require or are likely to require inspection. The method comprises identifying or determining a detailed procedure for the inspection of each object 10. The detailed procedure is determined in dependence on a probable defect or failure type/s; and comprises an associated, preferably validated, method for detecting such defects or failures. The detailed procedure is determined in dependence on the analysis, such as an FM EA.

The steps of the method is in any order. The method of inspecting the object 10 is referred to as a method of inspection.

It is an advantage of the present invention that the method of inspection is equivalent or at least substantially equivalent, such as in quality and/or scope, to the inspection that a competent person would achieve with a conventional inspection, such as a prescribed or certified inspection or detailed inspection. It is an advantage of the present invention that the method of inspecting the object 10 is in a manner and/or quality and/or resolution at least equivalent to that required by regulation. The manner and/or quality and/or resolution is at least equivalent to that obtainable by conventional inspection or general inspection, or at least comparable thereto. The manner and/or quality and/or resolution is at least equivalent to that obtainable by visual inspection, or at least comparable thereto. The manner and/or quality and/or resolution is at least equivalent to that obtainable by electrical testing. It is an advantage of the present invention that the method of inspecting the object 10 is in a manner and/or quality and/or resolution at least equivalent to that which a skilled surveyor or engineer would achieve if they had access to the object 10, such as with dismantling or disassembly, and optionally isolation, of the object 10.

It is an advantage of the present invention that the method of inspecting the vessel is in a manner and/or quality and/or resolution at least equivalent to that required by regulation. The manner and/or quality and/or resolution is at least equivalent to that obtainable by ultrasonic thickness measurement, or at least comparable thereto. It is an advantage of the present invention that the method of inspecting the vessel is in a manner and/or quality and/or resolution at least equivalent to that which a skilled surveyor or engineer would achieve if they had access to all parts of the vessel including within ‘arm's length’ of components, such as subject to a Close Visual Inspection, in particular if the skilled surveyor or engineer were inside the vessel and had such access.

Inspecting the vessel comprises inspecting an inside of the vessel. The method comprises inspecting the vessel without a person entering or being required to enter the vessel. The method comprises the entry of only apparatus, such as scanning apparatus, into the vessel.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as disclosed in any aspect, example, claim or embodiment of this disclosure, and a machine-readable storage storing such a program. Still further, embodiments of the present disclosure may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of inspecting at least a portion of a pressure system, the method comprising analysing data to predict a property of the portion of the pressure system, the predicted property being predicted for a particular use parameter, the method comprising determining an amount of data to collect at a next inspection of the portion of the pressure system.

2. The method of claim 1, wherein the predicted property is associated with a life of the portion of the pressure system such that a development of the property is predicted over a period of time.

3. The method of claim 1, wherein the property comprises an existing property of the portion of the pressure system.

4. The method of claim 1, wherein the property comprises a future property of the portion of the pressure system.

5. The method of claim 1, wherein the method comprises determining a predicted wall thickness of the portion of the pressure system at one or more locations of the portion of the pressure system.

6. The method of claim 5, wherein the method comprises compiling historical data and determining the predicted wall thickness in dependence on the historical data; and wherein the historical data comprises data for another object with one or more similar features to the portion of the pressure system for which the wall thickness is to be predicted.

7. The method of claim 6, wherein the historical data comprises data for the portion of the pressure system for which the wall thickness is to be predicted, compiled from previous inspections, measurement/s and determinations; and wherein the method comprises determining a number of thickness readings required to confirm the predicted wall thickness.

8. (canceled)

9. (canceled)

10. The method of claim 1, wherein the method comprises determining the amount of data to collect to satisfy a level of certainty and probability.

11. The method of claim 1, wherein the method comprises corroborating that sufficient data has been collected to confirm that the predicted property has been predicted with at least a minimum level of certainty; and wherein the method comprises determining whether sufficient data is being collected during an inspection to confirm the predicted property to the level of certainty.

12. (canceled)

13. The method of claim 1, wherein the method comprises determining whether the predicted property is above a minimum safe threshold.

14. The method of claim 1, wherein the method comprises providing a trigger to inspect and/or repair or replace the portion of the pressure system where the predicted property drops to the threshold.

15. The method of claim 1, wherein the method comprises at least one of: determining the predicted property in advance of an inspection; and determining the predicted property when no inspection is scheduled.

16. The method of claim 1, wherein the method comprises generating a model of the portion of the pressure system and the property thereof, the model comprising an effective fingerprint associated with the portion of the pressure system; and wherein the method comprises fingerprinting the pressure system, including associating each pressure system with a unique data set, the unique data set being indicative of the property of the portion of the pressure system at a plurality of locations of the portion of the pressure system.

17. (canceled)

18. The method of claim 1, wherein the method comprises providing an indication to the user whether sufficient data is or has been collected, and wherein the method comprises providing notification and determinations during inspection such that the method comprises notifying the user during inspection when sufficient data has been gathered during the inspection.

19. (canceled)

20. The method of claim 1, wherein the method comprises minimising an amount of data required by a single inspection; and wherein the method comprises minimising the number, resolution and frequency of inspections.

21. (canceled)

22. The method of claim 1, wherein the method comprises adapting the model in dependence on data gathered by each inspection, including adapting the model to refine the prediction and the amount of data to collect, such as to reduce the amount of data to collect within a level of certainty.

23. The method of claim 1, wherein the method comprises at least mitigating against an unexpected loss of containment of the fluids inside high risk piping or pressure vessels.

24. The method of claim 1, wherein the pressure system comprises a vessel which is part of at least one of
a moving ship;
a Floating Production, Storage and Offloading unit (FPSO);
a Mobile Offshore Drilling Unit; and
an Accommodation Vessel.

25. The method of claim 1, wherein the portion of the pressure system is for a hazardous environment.

26. Computer software which, when executed by a processing means, is arranged to perform a method according to claims 1, wherein the computer software is stored on a computer readable non-transitory medium.
